(19) United States
(12) Patent Application Publication
(10) Pub. No.: US 2004/0059683 A1
(43) Pub. Date: Mar. 25, 2004

(54) Automated multi-level marketing system

(76) Inventors: Steve Epstein, Hashmonaim (IL); David Samuel Chechik, Yeduda (IL)

Correspondence Address: LADAS & PARRY, 26 WEST 61ST STREET, NEW YORK, NY, 10023, US

(21) Appl. No.: 10/398,572

(22) PCT Filed: Oct. 10, 2001
(86) PCT No.: PCT/IL01/00939

(51) Int. Cl. G06F 17/60

(52) U.S. Cl. 705/64

(57) ABSTRACT

A method for automated multi-level marketing of an electronic item. The method includes providing a secured electronic item originating from a distributor, and a first user packaging a copy of the secured electronic item with secured payment details for the first user to receive a payment, thereby producing a packaged secured electronic item. Related apparatus and methods are also described.

### FIELD OF THE INVENTION

The present invention relates to marketing of electronic content in general, and in particular to super distribution of electronic content.

### BACKGROUND OF THE INVENTION

The term “business” in all its forms, as used throughout the present specification and claims, refers in a broad sense to any entity which sells goods or services.

The term “person” in all of its forms, as used throughout the present specification and claims, refers to any one or more of: a natural person; an artificial person; and an entity such as a computational entity which is operative to carry out actions described herein as being carried out by a person.

The term “worker” in all its forms, as used throughout the present specification and claims, refers to a person who works for a business.

The term “recruit” in all its forms, as used throughout the present specification and claims, refers to a new person who has been recruited to work for a business by a worker.

The term “e-commerce” in all its forms, as used throughout the present specification and claims, refers to use of the Internet for business-to-consumer transactions and business-to-business transactions. E-commerce is made possible by Internet Security technologies including secure socket layer (SSL) and Internet Protocol Security (IPSec).

The term “electronic banking” in all its forms, as used throughout the present specification and claims, refers to banking transactions that are conducted via computer technology including the Internet.

The term “secure socket layer (SSL)” in all its forms, as used throughout the present specification and claims, refers to a well-known an Internet security standard that is supported by many web browsers and web servers. SSL is independent of application and works with many Internet tools, not just the World Wide Web (WWW).

The term “World Wide Web (WWW)” in all its forms, as used throughout the present specification and claims, refers to a well-known global system of hypertext that uses the Internet as its transport mechanism.

The term “secured” in all its forms, as used throughout the present specification and claims, refers to use of precautionary measures taken to prevent illicit use of information and access to or tampering of said information by unauthorized users. For example, a secured data item may be scrambled and/or encrypted.

The term “scrambled” in all its forms, as used throughout the present specification and claims, refers to any item which has been processed by any appropriate method of scrambling, encoding, or encrypting data; many such methods being well-known in the art.

The term “super distribution” in all its forms, as used throughout the present specification and claims, refers to a mechanism which allows end users to send electronic content to further potential users of the content. Typically, further potential users will only be able to utilize the content upon registration and receipt of a license from a source other than the end user who sent the electronic content. Registration and receipt of a license may entail making an appropriate payment in order to open the file. Payment which is paid in super distribution is made to the provider of the license, not to the end user who sent the electronic content.

Multi-level marketing is a method which is utilized to sell and distribute goods.

Multi-level marketing for selling consumer goods is well known. When a worker at a business which utilizes multi-level marketing recruits additional workers, he receives income from all of the sales that his recruits make. The worker may also receive additional income from each new person that his recruits recruit, with some predefined limit as to the number of generations or ad infinitum.

When a worker has several workers under him, he may also stop making sales himself and focus on managing the sales force under him.

Reference is now made to FIG. 1, which is a simplified pictorial illustration of a prior art multi-level marketing scheme.

The scheme of FIG. 1, generally designated 100, preferably comprises the following components:

1. A warehouse 105 containing a business' product line. For the sake of simplicity of description, the warehouse 105 in FIG. 1 comprises a plurality of one product, canisters of “Vital Vitamins” 110.

2. A plurality of workers 120.

For example, Bob, the founder of “Vital Vitamin” 125 recruited a plurality of people, including Tom 130 and David 135, to sell “Vital Vitamins”. At a moment of time that is depicted in FIG. 1, Bob is no longer initiating direct sales to the consumer. He is focusing on effectively managing his vitamin empire, exploring potential new product lines, and keeping abreast of the latest vitamin/nutritional research.

Bob 125 obtains vital vitamins 110 from the warehouse 105 and routes them to the workers he has directly recruited. Bob 125 routes a supply of vital vitamins 110 which meet the sales needs of that recruit and all of the recruits under him to each of his direct recruits, including Tom 130 and David 135.

It is appreciated that Bob need not himself engage in physical routing of vital vitamins 110, but may alternatively see to it that the vitamins are routed by any appropriate means. Alternatively vital vitamins 110 may be routed from the vitamin warehouse by any appropriate means 105 directly to recruits.

It is important to note that in the multi-level marketing scheme Bob is encouraged to help his workers sell more vitamins because he is rewarded for each sale that his workers make. Bob 125 makes money from each sale that Bob's direct recruits make and each sale that the recruits of Bob's recruits make ad infinitum, or with some limit as dictated by the rules of the multi-level marketing scheme.

Tom 130 is involved in direct sales with customers as well as managing the workers under him. Every time Tom 130 sells a canister of “Vital Vitamins” 110, Tom keeps a percentage of the money from the sale and routes the remainder back to Bob 125. Tom 130 receives a portion of the money from every sale made by someone Tom has recruited to work for the “Vital Vitamin” company, and from the recruits of his recruits ad infinitum. Tom 130 takes a percentage of the moneys routed to him and then routes the remainder back to Bob 125.

David 135 is no longer involved in direct vital vitamin 110 sales and focuses his energies on managing the workers under him. David 135 receives a portion of the money from every sale made by someone David has recruited to work for the “Vital Vitamin” company and from the recruits of his recruits ad infinitum. David 135 takes a percentage of the moneys routed to him and then routes the remainder to Bob 125.

Tom 130 has recruited numerous workers including George 140 and Henry 145. George 140 and Henry 145 obtain vital vitamins 110 from Tom 130, which they then sell to clients. George 140 and Henry 145 keep a percentage of every sale of vital vitamins 110 that they make and then George and Henry route the remainder of the money to Tom 130. Tom 130 keeps a percentage of the moneys routed to him and then Tom routes the remainder to Bob 125.

David 135 has recruited numerous workers including Emma 150 and Elizabeth 155. Emma 150 and Elizabeth 155 obtain vital vitamins 110 from David 135, which Emma and Elizabeth then sell to clients. Emma 150 and Elizabeth 155 keep a percentage of every sale of vital vitamins 110 that they make and then they route the remainder of the money to David 135. David 135 keeps a percentage of the moneys routed to him and then David routes the remainder to Bob 125.

George 140 has recruited numerous workers including Tyler 160 and Harvey 165. Tyler 160 and Harvey 165 obtain-vital vitamins 110 from George 140, which Tyler and Harvey then sell to clients. Tyler 160 and Harvey 165 keep a percentage of every sale of vital vitamins 110 that they make and then Tyler and Harvey route the remainder of the money to George 140. George 140 keeps a percentage of the moneys routed to him and then George routes the remainder to Tom 130. Tom 130 keeps a percentage of the money that George 140 routes to him and then Tom routes the remainder to Bob 125.

Henry 145 has recruited two workers Mary 170 and Kathy 165. Mary 170 and Kathy 175 obtain vital vitamins 110 from Henry 145, which they then sell to clients. Mary 170 and Kathy 175 keep a percentage of every sale of vital vitamins 110 that they make and then Mary and Kathy route the remainder of the money to Henry 145. Henry 145 keeps a percentage of the moneys routed to him and then Henry routes the remainder to Tom 130. Tom 130 keeps a percentage of the money that George 140 routes to him and then Tom routes the remainder to Bob 125.

Emma 150 has recruited two workers Lydia 180 and Jane 185. Lydia 180 and Jane 185 obtain vital vitamins 110 from Emma 150, which they then sell to clients. Lydia 180 and Jane 185 keep a percentage of every sale of vital vitamins 110 that they make and then Lydia and Jane route the remainder of the money to Emma 150. Emma 150 keeps a percentage of the moneys routed to her and then Emma routes the remainder to David 135. David 135 keeps a percentage of the money that Emma 150 routes to him and then David routes the remainder to Bob 125.

Elizabeth 155 has recruited numerous workers including Karen 190 and Jen 195. Karen 190 and Jen 195 obtain vital vitamins 110 from Elizabeth 155, which they then sell to clients. Karen 190 and Jen 195 keep a percentage of every sale of vital vitamins 110 that they make and then Karen and Jen route the remainder of the money to Elizabeth 155. Elizabeth 155 keeps a percentage of the moneys routed to her and then Elizabeth routes the remainder to David 135. 20 David 135 keeps a percentage of the money that Elizabeth 155 routes to him and then routes the remainder to Bob 125.

References describing multi-level marketing (MLM) systems include the following:

Internet World Wide Web (WWW) site “Multi-Level Marketing Directory” at http://www.multi-level-marketing.com advertises multi-level marketing offers.

WWW site “Multi Level Marketing Opportunity Resource” at http://multi-levelmarketingopportunity.hypermart.net/ includes a multi-level marketing sales pitch.

WWW site “Free Multi Level Marketing Reports at the Free Well: The Online Library of Free Reports” at http://www.freewell.com/freereports/multi_level.html includes a list of articles on the subject of multi-level marketing.

WWW article “The Bare-Bones Basics of Multi-Level Marketing” at http://www.freewell.com/freereports/multi_level/4.html describes the multi-level marketing business.

WWW article “What is Multi-Level and How Should it be Worked?” at http://www.freewell.com/freereports/multi_level/5.html describes the multi-level marketing business.

WWW site at http://www.amway.com/ is the website of Amway, a multi-level marketing business.

WWW article “Amway History” at http://www.amway.com/OurStory/o-hist.asp describes Amway's multi-level marketing history.

WWW article “What's Wrong With Multi-Level Marketing?” at http://www.vandruff.com/mlm.html describes limitations of the multi level marketing business.

T. Pack, “Digital Rights Management”, ECONTENT, Vol. 22, no. 4, August/September 1999, describes digital rights management technology.

WWW article “Electronic Right Management and Digital Identifier Systems” by D. Gervais describes issues associated with electronic rights management and implementations of electronic rights management including a digital object identifier.

WWW article “International Federation of Reproduction Rights Organisations (IFRRO) Detailed Papers” describes distribution and legal issues associated with reproduction of materials.

WWW article “Sources of Income for Music Makers” describes royalties and licensing mechanisms for music.

A reference describing the secure socket layer (SSL) protocol is: “The SSL Protocol Version 3.0, Transport Layer Security Working Group, Internet Draft,” Alan Freier, Philip Karlton and Paul Kocher, Nov. 18, 1996. The following references are also believed to represent the state of the art:

U.S. Pat. No. 6,266,654 B1 to Schull;

U.S. Pat. No. 5,509,070 to Schull;

U.S. Pat. No. 6,134,533 to Shell;

U.S. Pat. No. 6,202,056 B1 to Nuttall;

U.S. Pat. No. 5,991,402 to Jia et al.;

U.S. Pat. No. 5,537,314 to Kanter;

U.S. Pat. No. 6,105,001 to Masi et al.;

U.S. Pat. No. 5,933,498 to Schneck et al.;

U.S. Pat. No. 6,236,971 B1 to Stefik et al.;

U.S. Pat. No. 5,715,403 to Stefik;

U.S. Pat. No. 5,638,443 to Stefik et al.;

U.S. Pat. No. 5,634,012 to Stefik et al.;

U.S. Pat. No. 5,629,980 to Stefik et al.;

U.S. patent application Ser. No. 2001/0014882 A1 to Stefik et al.; and

U.S. patent application Ser. No. 2001/0010045 A1 to Stefik et al.

The disclosures of all references mentioned above and throughout the present specification are hereby incorporated herein by reference.

### SUMMARY OF THE INVENTION

The present invention seeks to provide an improved method for distribution of electronic content, which utilizes a subscriber's desire to send content to the subscriber's potential recruits to increase distributor revenues.

In a preferred embodiment, the present invention seeks to provide apparatus and methods for selling and distributing electronic content via multi-level marketing.

There is thus provided in accordance with a preferred embodiment of the present invention a packaged secured electronic item including a secured electronic item originating from a distributor, and secured payment details for a first user to receive a payment associated with use of the secured electronic item by a second user.

There is thus provided in accordance with another preferred embodiment of the present invention a method for automated multi-level marketing of an electronic item, the method including providing a secured electronic item originating from a distributor, and a first user packaging a copy of the secured electronic item with secured payment details for the first user to receive a payment, thereby producing a packaged secured electronic item.

Further in accordance with a preferred embodiment of the present invention the method also includes transmitting the packaged secured electronic item to a second user.

Still further in accordance with a preferred embodiment of the present invention the method also includes the second user obtaining, from the distributor, permission to use the electronic item, and the second user providing a payment to at least one of the following: the distributor, and the first user.

Additionally in accordance with a preferred embodiment of the present invention the second user providing a payment includes the second user providing a payment in accordance with a payment rule.

Moreover in accordance with a preferred embodiment of the present invention the payment rule is automatically managed.

Further in accordance with a preferred embodiment of the present invention the payment rule is automatically managed in accordance with at least one rule expressed in a payment rule language.

Still further in accordance with a preferred embodiment of the present invention the payment rule is automatically enforced.

Additionally in accordance with a preferred embodiment of the present invention the payment rule is modifiable.

Moreover in accordance with a preferred embodiment of the present invention the payment rule is modifiable during a life span of a product with which the payment rule is associated.

Further in accordance with a preferred embodiment of the present invention the payment rule comprises at least one of the following a rental rule, a pay-per-play rule, a pay-per-use rule, a buy rule, and a distributor payment rule.

Still further in accordance with a preferred embodiment of the present invention the distributor payment rule includes at least one of the following a rule determining distributor payment based, at least in part, on paid usage by a distributor, and a rule determining distributor payment based, at least in part, on whether a distributor has paid a monthly distributor fee.

Additionally in accordance with a preferred embodiment of the present invention the rule includes information specifying an amount to be paid and a payment recipient associated with +he amount to be paid.

Moreover in accordance with a preferred embodiment of the present invention the second user provides a payment to at least one of the following the distributor, and the first user.

Further in accordance with a preferred embodiment of the present invention the second user provides a payment to both the distributor and the first user.

Still further in accordance with a preferred embodiment of the present invention the payment is paid online.

Additionally in accordance with a preferred embodiment of the present invention the payment is paid offline.

There is thus provided in accordance with another preferred embodiment of the present invention a method for multi-level marketing of an electronic item, the method including a second user receiving a packaged secured electronic item including a secured electronic item originating from a distributor, and secured payment details for a first user to receive a payment, the second user obtaining, from a distributor of the electronic item, permission to use the electronic item, and the second user providing a payment to at least one of the following: the distributor, and the first user.

Further in accordance with a preferred embodiment of the present invention the second user provides a payment to both the distributor and the first user.

Still further in accordance with a preferred embodiment of the present invention the payment is paid online.

Additionally in accordance with a preferred embodiment of the present invention the payment is paid offline.

There is thus provided in accordance with still another preferred embodiment of the present invention a method for automated multi-level marketing of an electronic item, the method including: providing a secured electronic item originating from a distributor, and a first user packaging a copy of the secured electronic item with secured payment details for the first user to receive a payment, thereby producing a packaged secured electronic item, the first user sending the packaged secured electronic item to a second user, and the second user packaging a copy of the secured electronic item with secured payment details for the second user to receive a payment, thereby producing a modified packaged secured electronic item.

Further in accordance with a preferred embodiment of the present invention the method also includes transmitting the packaged secured electronic item to a third user.

Still further in accordance with a preferred embodiment of the present invention the third user obtaining, from the distributor, permission to use the electronic item, and the third user providing a payment to at least one of the following: the distributor, the first user, and the second user.

Additionally in accordance with a preferred embodiment of the present invention the third user providing a payment includes the third user providing a payment in accordance with a payment rule.

Moreover in accordance with a preferred embodiment of the present invention the payment rule is automatically managed.

Further in accordance with a preferred embodiment of the present invention the payment rule is automatically enforced.

Still further in accordance with a preferred embodiment of the present invention the rule includes information specifying an amount to be paid and a payment recipient associated with the amount to be paid.

Additionally in accordance with a preferred embodiment of the present invention the third user provides a payment to at least one of the following the distributor, the first user, and the second user.

Moreover in accordance with a preferred embodiment of the present invention the third user provides a payment to the distributor, the first user, and the second user.

Further in accordance with a preferred embodiment of the present invention the user provides a payment to the distributor, the first user, and the second user.

Still further in accordance with a preferred embodiment of the present invention the payment is paid online.

Additionally in accordance with a preferred embodiment of the present invention the payment is paid offline.

Moreover in accordance with a preferred embodiment of the present invention the secured payment details include tamper-evident secure payment details.

Further in accordance with a preferred embodiment of the present invention the tamper-evident secure payment details include iteratively signed secure payment details.

Still further in accordance with a preferred embodiment of the present invention the method also includes determining an identity of an entity who has tampered with the tamper-evident secure payment details.

Additionally in accordance with a preferred embodiment of the present invention the method also includes blacklisting the entity who has tampered with the tamper-evident secure payment details.

There is thus provided in accordance with yet another preferred embodiment of the present invention a secure payment item including a tamper-evident secure payment list including a plurality of iteratively signed secure payment details.

Further in accordance with a preferred embodiment of the present invention a method for producing tamper-evident secured payment details including iteratively signing each of a plurality of secured payment details.

Still further in accordance with a preferred embodiment of the present invention a method for frustrating tampering with payment details, the method including providing tamper-evident secured payment details, and determining an identity of an entity who has tampered with the tamper-evident secured payment details.

Additionally in accordance with a preferred embodiment of the present invention the method also includes blacklisting the entity who has tampered with the tamper-evident secure payment details.

There is thus provided in accordance with another preferred embodiment of the present invention a method for multi-level marketing of an electronic item, the method including a third user receiving a packaged secured electronic item including a secured electronic item originating from a distributor, and secured payment details for at least one of a first user and a second user to receive a payment, the third user obtaining, from a distributor of the electronic item, permission to use the electronic item, and the third user providing a payment to at least one of the following the distributor, the first user, and the second user.

Further in accordance with a preferred embodiment of the present invention the third user provides a payment to both the distributor and the first user.

Still further in accordance with a preferred embodiment of the present invention the third user provides a payment to the distributor, the first user, and the second user.

Additionally in accordance with a preferred embodiment of the present invention the payment is paid online.

Moreover in accordance with a preferred embodiment of the present invention the payment is paid offline.

### BRIEF DESCRIPTION OF THE DRAWINGS

The present invention will be understood and appreciated more fully from the following detailed description, taken in conjunction with the drawings in which:

FIG. 1 is a simplified pictorial illustration of a prior art multi-level marketing scheme;

FIG. 2 is a simplified partly pictorial, partly block diagram illustration of a system for the super distribution of electronic content, constructed and operative in accordance with a preferred embodiment of the present invention;

FIG. 3 is a simplified partly pictorial, partly block diagram illustration of a preferred implementation of a multi-level product manager which implements super distribution of electronic content in accordance with the embodiment of FIG. 2;

FIG. 4 is a simplified block diagram illustration of a preferred implementation of a file rendering system utilizable for the super distribution of electronic content in accordance with the preferred implementation of FIG. 3;

FIG. 5 is a simplified functional block diagram illustration of a preferred implementation of a multi-level payment gateway which implements a payment policy associated with super distribution of electronic content in accordance with the preferred implementation of FIG. 3;

FIG. 6 is a simplified flowchart illustration of a preferred method of operation of the systems of FIGS. 2 and 3;

FIG. 7 is a simplified flowchart illustration of an alternative preferred method of operation of the systems of FIGS. 2 and 3;

FIG. 8 is a simplified flowchart illustration of another preferred method of operation of the systems of FIGS. 2 and 3;

FIG. 9 is a simplified flowchart illustration of a further alternative preferred method of operation of the systems of FIGS. 2 and 3;

FIG. 10 is a simplified flowchart illustration of another preferred method of operation of the systems of FIGS. 2 and 3; and

FIG. 11 is a simplified flowchart illustration of a further alternative preferred method of operation of the systems of FIGS. 2 and 3.

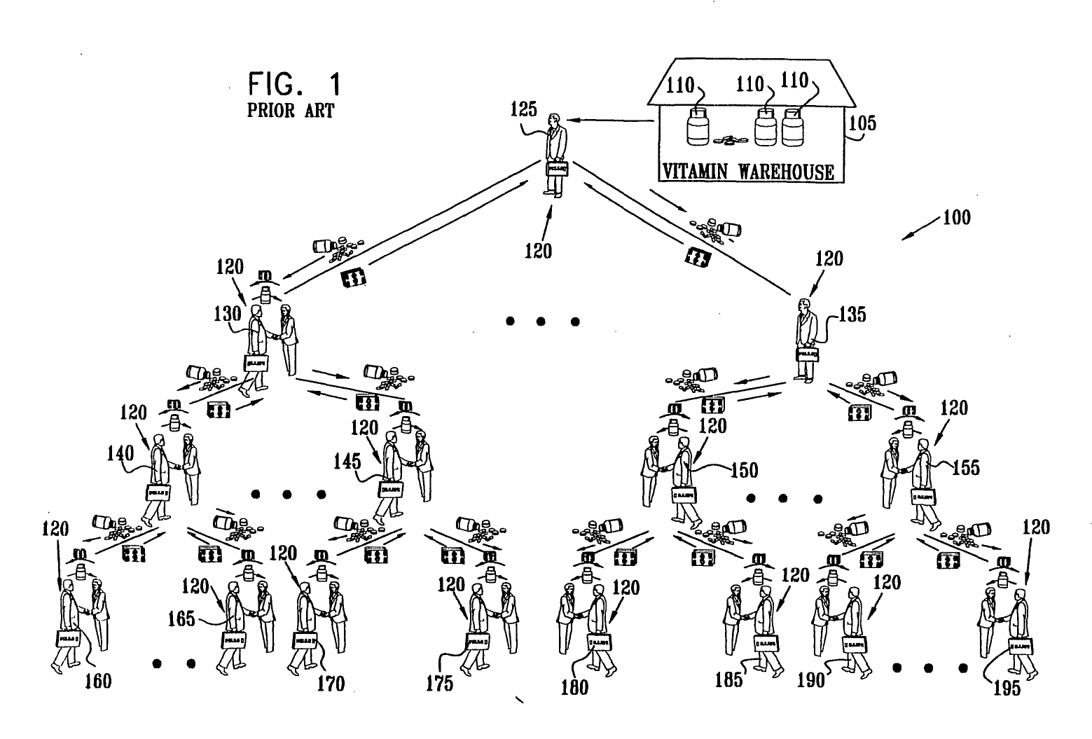

### DETAILED DESCRIPTION OF A PREFERRED EMBODIMENT

The present invention, in preferred embodiments thereof, applies automated super distribution mechanisms to enhance the flexibility and automation of the multi level marketing business. The incentive for end users to distribute electronic content is increased, and security is enhanced by automating multi-level marketing using super distribution techniques. Unlike conventional multi-level marketing, which is limited to the sale of physical goods, the present invention is primarily applicable to the sale of electronically-distributable goods.

Furthermore, conventional multi-level marketing provides only for the sale of goods. The present invention, in preferred embodiments thereof, provides, in addition to sale, for the rental, pay per use, or any other appropriate method of billing for consumption or other use of electronic content.

In preferred embodiments of the present invention, a unique user identification (ID) is associated with each end user, or alternatively, with that end user's host computer. Each unique user ID enables the associated end user to be uniquely identified by the system.

In certain preferred embodiments, the present invention enhances super distribution technology to authorize the distribution of electronic content, provide payment protocols for the distribution of electronic content, guarantee the security of electronic content and associated end user information, and guarantee the integrity of payments to end users via preferably flexible payment generation rules. The multi level marketing of electronically-distributable goods is accomplished via secured headers, automated electronic transmission, and automatic rule generation for payment administration.

Various safety checks may preferably be used, including sanity checks which prevent one user from sending a file to himself multiple times to accrue added benefits with a distributor. However, a user may send a file to himself multiple times if the user is forced to pay each time the user renders the content on a separate host. Security checks may also preferably be used to prevent the distributor from paying out more revenue than has been received.

Abusers of the system may also preferably be prevented from using the system in the future. The names of abusers of the system will preferably no longer be added to the header when the abusers distribute electronic media. An ongoing licensing fee may also be automatically deducted from a users credit card or bank account on a periodic basis to pay for the privilege of being an end user who receives revenue generated by the materials that the end user distributes.

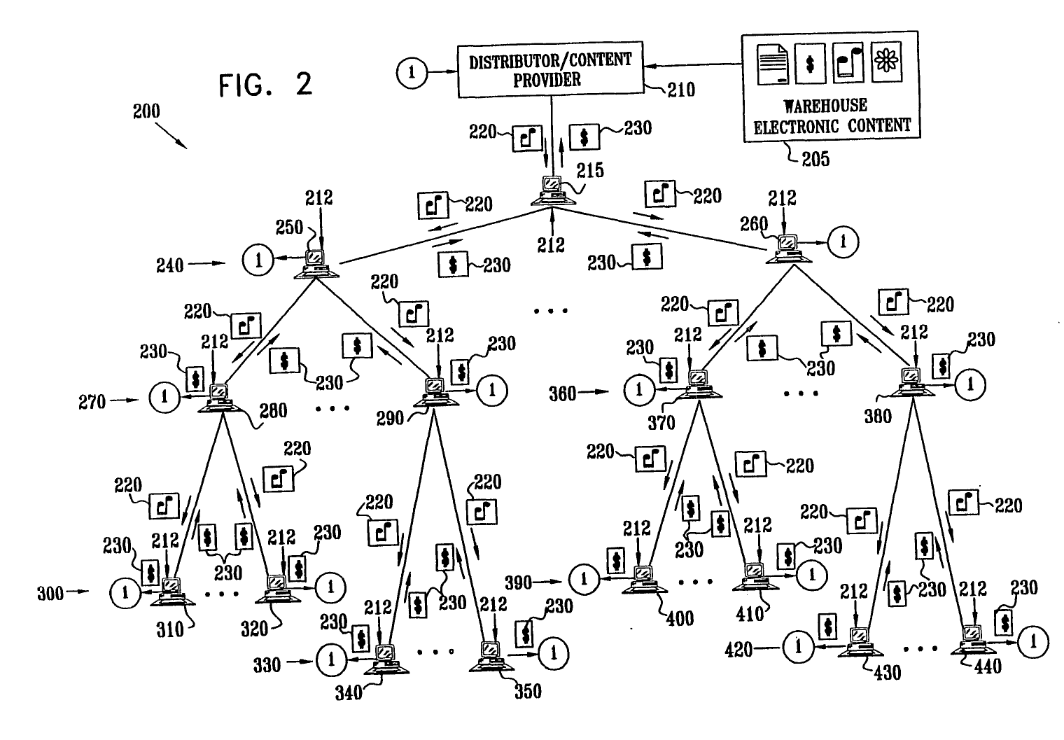

Reference is now made to FIG. 2, which is a simplified partly pictorial, partly block diagram illustration of a system for the super distribution of electronic content, constructed and operative in accordance with a preferred embodiment of the present invention.

The system of FIG. 2, generally designated 200, preferably comprises the following components, each of which may be implemented in a suitable combination of hardware and software as is well known in the art:

1. A warehouse 205 containing electronically-distributable goods, such as electronic content available for distribution.

2. A distributor/content provider 210.

3. A plurality of user units, generally designated 212, and comprising, in the example of FIG. 2, the following user units: a first user's user unit 215; a second user's user unit 250; an mth user's user unit 260; a third user's user unit 280; an nth user's user unit 290; a sixth user's user unit 370; an sth user's unit 380; a fourth user's user unit 310; a pth user's user unit 320; a fifth user's user unit 340; an rth user's computer 350; a seventh user's user unit 400; a qth user's unit 410; an eighth user's user unit 430; and a vth user's unit 440, all of which are further described below. As described above, each user unit may be implemented in any appropriate combination of hardware and software , as is well known in the art.

In a preferred embodiment of the present invention, a first user (not shown) uses the first user's user unit 215 to obtain secured electronic content 220 from the distributor/content provider 210. Secured electronic content 220 may comprise: video; audio/video; audio such as music; a picture; a computer program; and any combination of one or more of the preceding.

The first user pays for use of secured electronic content 220 via a payment mechanism 230. It is appreciated that electronic payment need not be incurred at the time of the transaction. For example, electronic payment may be incurred on a periodic basis, such as, for example, every night, once a week, or once a month. Alternatively or additionally, electronic payment may be incurred only when an amount to be paid exceeds a predetermined threshold.

As is well known in the art, a facility may preferably be provided with a preview functionality for allowing the first user and any additional users recruited by the first user to view a brief unscrambled portion of the content before deciding whether or not to pay to obtain the content.

The payment mechanism 230 may be on-line or off-line. Payment may be based on the amount of time secured electronic content 220 is in the end user's possession, on the number of plays, the ownership class, or any other relevant factor. Payment might also be one unvarying lump sum payment. Payment could be, for example, event based, calendar based, transaction based, or threshold based.

Payment mechanism 230 is preferably utilized by the first user as is well as all subsequent users to pay the distributor/content provider 210. Appropriate payment mechanisms are well-known in the art.

In the prior art, it is believed that users of electronic content frequently inform their acquaintances of interesting electronic content and that users frequently send their acquaintances interesting free electronic content and may even illegally send unlicensed copies of electronic-content which is not free to their acquaintances, thereby denying potential sources of revenue to the providers and distributors of electronic content.

The present invention, in preferred embodiments thereof, is intended to harness the user's natural desire to send electronic content to the user's acquaintances as a means of generating revenue for the distributor/content provider 210. In the present invention, this natural desire is further encouraged by the prospect of financial reward for the user himself.

In some preferred embodiments of the present invention, distributing electronic content to the user's acquaintances, or even to persons unknown to the user, may also generate revenue for the user.

The first user uses the first user's user unit 215 to send secured electronic content 220 to a plurality of the first user's potential recruits' user units 240, including the second user's user unit 250 and the mth user's user unit 260.

The plurality of the first users potential recruits' user units 240, including the second user's user unit 250 and the mth user's user unit 260, each preferably needs to obtain a license (not shown) from the distributor/content provider 210 before opening or using secured electronic content 220. Preferably, the distributor/content provider 210 requires a payment in order to provide the license. In this way the distributor/content provider 210 makes money from copying instead of losing money from copying. Appropriate licensing methods are well known in the art.

All of the potential recruits of the first user who would like to use secured electronic content 220 will preferably need to pay the distributor/content provider 210, preferably via payment mechanism 230 or otherwise, in order to obtain a license.

The first user may obtain a portion of the payment made via payment mechanism 230 by the first user's direct descendents. The first user may be paid based only on the use of potential recruits to whom the first user sent secured electronic content 220 directly. Alternatively the first user may also receive additional income from each new user that the plurality of the first users potential recruits' “recruit” to use secured electronic content 220, either with some predefined limit or ad infinitum. Preferably, a user is paid based on the use of the secured electronic content 220 by recruits the user helped to recruit as an incentive to the user to legally distribute the content.

Payment may be made, for example, directly to persons who are users of the electronic content or to computers associated with the user, such as the computer that administers the user's bank account. It is appreciated that many appropriate mechanisms for payment are available, and that the preceding example is not meant to be limiting.

Preferably, one or more rules are used to govern payment for use of the secured electronic content 220. For example, the first user may be paid the same amount for all users that are descended from the first user's initial use of secured electronic content 220. The first user may alternatively be paid on a sliding scale, receiving less money for each generation which is further removed from the first user's transmission of secured electronic content 220 to potential recruits. Payment administration is based on how the content provider creates a payment rule. Payment rules are preferably based on an automated language, termed herein a Multi-level Payment Language (MLPL).

Similarly, all recruiters may be paid on a sliding scale. For example, the mth's user's user unit 260 may be paid less for the mth user's efforts which led to the recruitment of the eighth user's user unit's 430 utilization of secured electronic content 220 than for the mth user's efforts which led to the recruitment of the sixth user's user unit's 370 utilization of secured electronic content 220.

Any payments made to recruiters are preferably in addition to payments made to the distributor/content provider 210.

It is appreciated that any appropriate rules governing payment may be used; that the payment rules described above are by way of example only and are not meant to be limiting; and that, in practice, a very wide variety of different payment rules might be used depending on business considerations.

In one preferred embodiment of the present invention, the end user will have a tamper resistant unit, preferably a removable security unit such as a smart card (not shown in FIG. 2) or some other secure device (not shown in FIG. 2) and/or tamper resistant software (TRS) (not shown in FIG. 2), comprising information defining the end users' bank or payment information as well as appropriate transaction information.

An access rights protocol may comprise an XML protocol or any other appropriate access protocol. The access rights protocol may contain information on how much to pay “per file open”, “per time per use”, and/or for any other appropriate access-related parameter or parameters. The access rights protocol preferably resides in the domain of the distributor/content provider 210 and is accessed when a user attempts to access secured electronic content 220. The access rights protocol is the protocol which determines how secured electronic content 220 may be accessed, by whom, and under what conditions. Identifying information, which will enable users in good standing to be paid for their distribution efforts, is preferably copied into the access rights protocol.

Before copying secured electronic content 220 to the plurality of the first user's potential recruits' user units 240, the first user's user unit 215 preferably imbeds the first user's secure identification securely into the access rights protocol.

The first user's secure identification is preferably used to enable payment, possibly by accessing corresponding bank information which is stored at a Subscriber Management System (SMS) 560 in the headend corresponding to the distributor/content provider 210. The first user's secure identification may be in encrypted form or in any other appropriate secure format.

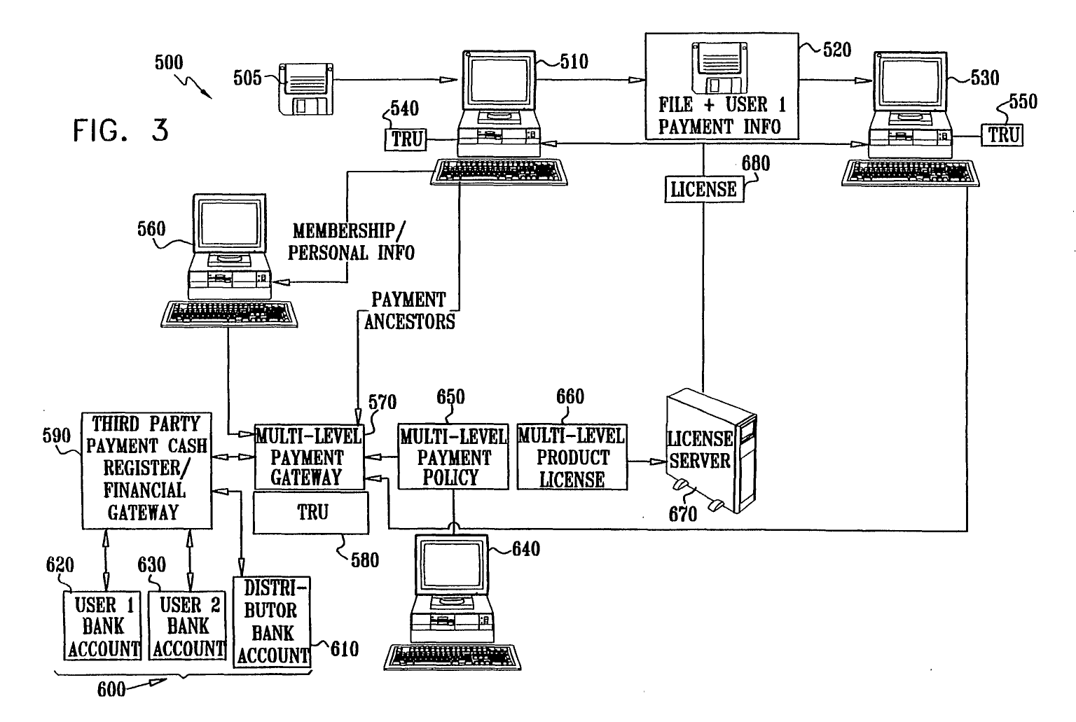

Alternatively, the first user may incorporate his ID and his order in the chain of ancestors. Preferably, the first user's actual bank information may be held at the SMS 560, as shown below in FIG. 3. This preferred embodiment implicitly requires that each user register with the distributor/content provider 210 before being granted the rights and payments to become a distributor of the secured electronic content 220.

In another alternative preferred embodiment in which the user's bank information, and not a corresponding ID, is encrypted into the secured electronic content 220, users who have not registered may also use the system and be paid for their efforts.

In another alternative embodiment of the present invention, a central facility which comprises a central database, with the payment details for all of the end users and the distributor/content provider 210, coordinates payments to end users and to the distributor/content provider 210.

When the plurality of the first user's potential recruits' user units 240, including the second users user unit 250 and the mth user's user unit 260, obtain a license from the distributor/content provider 210 and securely open-the secured electronic content 230, the plurality of the first user's potential recruits' user units 240 pay the distributor/content provider 210 as well as the first user.

The payment mechanism 230 may secure an e-commerce or electronic banking transaction, according to procedures that are very well known in the art, to the first user's bank, preferably based on rules contained in the access rights protocol.

The second user preferably uses the second user's user unit 250 to send secured electronic content 220 to a plurality of the second user's potential recruits' user units 270, including a third user's user unit 280 and an nth user's user unit 290.

The second users potential recruits' user units 270, including the third user's user unit 280 and the nth user's user unit 290, preferably need to obtain a license (not shown) from the distributor/content provider 210 before opening or using secured electronic content 220.

All of the potential recruits of the second user who would like to use secured electronic content 220 will preferably need to pay via payment mechanism 230 the distributor/content provider 210 in order to obtain a license. The second user and possibly the first user will be paid by each of the potential users the second user succeeds in recruiting to view secured electronic content 220. All potential recruits of all users ad infinitum preferably need to obtain a license via the payment method described above before being authorized to view secured electronic content 220.

In general terms, the user may need to obtain a license, and the user may need to pay to be licensed. The license enables the user to derive benefit from the secured electronic content 220. The license may be obtained when payment is received via the payment mechanism 230 and routed to the distributor/content provider 210. The ancestral chain of users that connected the current user to the distributor/content provider 210 may also receive payment from the licensing fee for their recruitment efforts.

The second user may obtain a portion of the payment made via payment mechanism 230 by his direct descendents. The second user may be paid, via an automatic electronic transaction, based only on the use of potential recruits to whom the second user directly sent secured electronic content 220. The second user may also receive additional income from each new user that the plurality of the second users potential recruits “recruit” to use secured electronic content 220 with some predefined limit or ad infinitum.

Each user may preferably receive payment if he actually paid for rendering secured electronic content 220. In some preferred embodiments of the present invention, the more a user paid for rendering electronic content, the more revenue he may be authorized to receive from his descendents.

The third user uses the third user s user unit 280 to send secured electronic content 220 to a plurality of the third user's potential recruits' user units 300, including a fourth user's user unit 310 and a pth user's user unit 320. The fourth user's user unit 310 and the pth user's user unit 320 could be used to forward secured electronic content to other users according to some predefined limit or ad infinitum.

The nth user uses the nth user's user unit 290 to send secured electronic content 220 to a plurality of the nth user's potential recruits' user units 330, including a fifth user's user unit 340 and an rth user's user unit 350. The fifth user's user unit 340 and the rth user's user unit 350 could be used to forward secured electronic content to other users according to some predefined limit or ad infinitum.

The mth user uses the mth user's user unit 260 to send secured electronic content 220 to a plurality of the mth user's potential recruits' user units 360, including a sixth user's user unit 370 and an sth user's user unit 380.

The sixth user uses the sixth user's user unit 370 to send secured electronic content 220 to a plurality of the sixth user's potential recruits' user units 390, including a seventh user's user unit 400 and the qth user's user unit. The seventh user's user unit 400 and the qth user's user unit 410 could be used to forward secured electronic content 220 to other users according to some predefined limit or ad infinitum.

The sth user uses the sth user's user unit 380 to send secured electronic content 220 to a plurality of the sth user's potential recruits' user units 420, including the eighth user's user unit 430 and the vth user's user unit 440. The eight user's user unit 430 and the vth user's user unit 440 could be used to forward secured electronic content 220 to other users according to some predefined limit or ad infinitum.

Furthermore, end users may be billed monthly (or billed at any other appropriate interval) by the distributor/content provider 210 or by a broadcaster or other party (not shown) having appropriate legal rights to be paid, for the right to make money from copying and distributing secured electronic content 220. If a specific end user does not pay the required fee, the specific end user's becomes a specific end user who is not in good standing.

The name and identifying information of the specific end user who is not in good standing will preferably not be imbedded into the access rights protocol by the tamper resistant unit, preferably comprising a removable security unit such as a smart card. Each time the specific end user who is not in good standing copies the file, the specific end user who is not in good standing will preferably not be paid for recruitment efforts made. Payment rules will preferably be automatically specified in the MLPL.

The preferred embodiment of FIG. 2, if properly secured as described above, encourages every end user to copy the content to as many people as that end user may wish, where copying the content automatically makes that end user a partner in the business of the content provider/distributor 210. The preferred embodiment of FIG. 2 thereby enhances the ability for any content provider/distributor 210 to reach as many end users as possible and make as much money as possible from either paid content revenue or from advertising revenue.

In an alternative preferred embodiment of the present invention, content may be distributed for free to the end user, with the distributor/content provider 210 making money from advertising revenue; in such an embodiment, the greater the end user base, the greater the revenue stream from the advertiser.

In another preferred embodiment of the present invention, payment mechanism 230 may be used to pay only the distributor/content provider 210 and the user that directly recruited the current user.

Preferably, payments are not made from each end user directly to the previous end user who recruited that end user, all the way up the ancestral chain. Rather, as described above and also in more detail below with reference to FIGS. 3-7, payment is preferably made by the distributor/content provider 210 to each recipient of payment.

It is known in the art that, in conventional multi-level marketing systems, a great deal of overhead is associated with the marketing of products and payment bookkeeping. By contrast, in a preferred embodiment of the present invention, there are preferably little if any marketing costs. When the first user sends the second user electronic content, the second user may preferably receive a brief description, or a brief clip of the electronic content to view for free before payment is requested for the file By automating payment bookkeeping, a product marketed via the system described in FIG. 2 can be sold without incurring the costs of conventional human bookkeeping.

The payment rule is preferably automatically generated, maintained and implemented with the MLPL, thereby drastically reducing bookkeeping costs. Furthermore, there is tremendous flexibility in modifying the MLPL in order to keep abreast of the changing business needs of the content provider/distributor 210.

Reference is now made to FIG. 3, which is a simplified partly pictorial, partly block diagram illustration of a preferred implementation of a multi-level product manager which implements the super distribution of electronic content in accordance with the embodiment of FIG. 2.

The apparatus of FIG. 3. comprises a conceptual illustration of a preferred embodiment of a subsystem which preferably could be located at the site of the distributor/content provider 210 in which payment is distributed in accordance with rules specified in the MLPL.

Two non-limiting examples of MLPL rules, written for the purposes of the examples in the well-known XML language, are as follows:

### EXAMPLE 1

<?xml version=‘1.0’?>
<Products>

<example>

Here is an example of Multi-level Payment Policies using an example of a Multi-level Payment Language (MLPL).

The product “Star wars Movie, id 1234, may only be sold to own and costs $10. Pay 90% to the content provider, 2% to 5th generation ancestor, 2% 4th generation ancestor, 2% to a 3rd generation ancestor, 3% to a second generation ancestor, and 3% to the seller (1st generation ancestor)

</example>
<Product name=“Star Wars” id=“1234”>

<Payment Terms=“Buy”>

<Price>10</Price>

</Payment>
<Policy desc=“standard 5 generations”>

<ContentProvider>90</ContentProvider>
<Generation5>2</Generation5>
<Generation4>2</Generation4>
<Generation3>2</Generation3>
<Generation2>3</Generation2>
<Generation1>3</Generation1>

</Policy>

</Product>

</Products>

### EXAMPLE 2

<?xml version=‘1.0’?>
<Products>

<example>

Here is a sophisticated example of Multi-level Payment Policies using an example of a Multi-level Payment Language (MLPL).

The product “Raiders of the Lost Ark Movie, id 56789, costs $2 per play for up to 10 plays and $1 per play thereafter. The payment distribution is as follows: 3% to 5th generation ancestor if he spent more then $10—1% if he spent less, 3% to 4th generation ancestor if he spent more then $10—1% if he spent less, 3% to a 3rd generation ancestor if he spent more then $10—1% if he spent less, 4% to 2nd generation ancestor if he spent more then $10—2% if he spent less, and 5% to the seller (1st generation ancestor) if he spent more then $15, 4% if he spent more than $10, but less than $15—2% if he spent less. The provider receives the remaining amount of money.

</example>
<Product name=“Raiders of the Lost Ark” id=“56789”>

<Payment Terms=“Pay Per Play”>

<PlayThreshold>10</PlayThreshold>
<AbovePlayThreshold>

<PricePerPlay>1</PricePerPlay>

</AbovePlayThreshold>
<BelowPlayThreshold>

<PricePerPlay>2</PricePerPlay>

</BelowPlayThreshold>

</Payment>
<Policy desc=“5 generations as a function of amount spent”>

<Generation5 Threshold1=“10” Threshold2=“”>

<GreaterThanThreshold1>3</GreaterThanThreshold1>
<LessThanThreshold1>1</LessThanThreshold1>

</Generation5>
<Generation4 Threshold1=“10” Threshold2=“”>

<GreaterThanThreshold1>3</GreaterThanThreshold1>
<LessThanThreshold1>1</LessThanThreshold1>

</Generation4>
<Generation3 Threshold1=“10” Threshold2=“”>

<GreaterThanThreshold1>3</GreaterThanThreshold1>
<LessThanThreshold1>1</LessThanThreshold1>

</Generation3>
<Generation2 Threshold1=“10” Threshold2=“”>

<GreaterThanThreshold1>4</GreaterThanThreshold1>
<LessThanThreshold1>2</LessThanThreshold1>

</Generation2>
<Generation1 Threshold1=“15” Threshold2=“10”>

<GreaterThanThreshold1>5</GreaterThanThreshold1>
<BetweenThresholds>4</BetweenThresholds>
<LessThanThreshold2>2</LessThanThreshold2>

</Generation1>
<ContentProvider>Remainder</ContentProvider>

</Policy>

</Product>
</Products>

The multi-level product manager of FIG. 3, generally designated 500, preferably comprises the following components, each of which may be implemented in a suitable combination of hardware and software as is well known in the art:

1. Secured electronic content 505.

2. A first user's user unit 510, which by way of example only is shown as a PC, User 1 PC 510.

3. A file 520 preferably comprising secured electronic content and User 1 payment information.

4. A second user's user unit 530.

5. A User 1 tamper resistant unit (TRU) 540, which may comprise a removable security element such as a smart card or a similar removable security element, tamper resistant hardware and/or software, or any appropriate combination of the foregoing, and preferably comprising relevant User 1 information.

6. A User 2 TRU 550, preferably similar to the User 1 TRU 540 and preferably comprising relevant User 2 information.

7. The Subscriber management system (SMS) 560.

8. A Multi-level payment gateway 570.

9. A Multi-level payment gateway TRU 580.

10. A Third Party Payment “cash register”/financial gateway 590.

11. A plurality of bank accounts generally designated 600, and comprising, in the example of FIG. 3, the following bank accounts: a distributor bank account 610; a user 1 bank account 620; and a user 2 bank account 630. Each bank account may preferably be administered by separate banks.

12. A Multi-level product manager 640.

13. A Multi-level product payment policy unit 650.

14. A Multi-level product license unit 660.

15. A license server 670.

16. A license 680.

The operation of the apparatus of FIG. 3 is now briefly described.

Secured electronic content 505 is preferably delivered to user 1 user unit 510. User 1 enters membership/personal information including details on how payment for services will be paid and through what means recruiting other users will be financially rewarded; the membership/personal information is preferably sent to the subscriber management system 560. The information entered by user 1 is then sent by the subscriber management system 560 to the multi-level payment gateway 570 for further processing.

The Multi-level Product Manager 640 preferably creates a list of multi-level products preferably including:

1. A multi-level product payment policy unit 650.

2. A multi-level product license unit 660.

The multi-level product license 660 preferably includes:

1. A name and id of the Product.

2. A name and type of subscribers (geographic, income, rating etc.) that may enable the user to render the product, along with suitable decryption information for producing a decryption key for this product.

The term “rendering”, in all of its grammatical forms, is used throughout the present specification and claims to refer to doing any one or more of the following with electronic content: opening; using; displaying; making palpable to the senses; deriving benefit from in any manner; or otherwise consuming.

As is well known in the art, the decryption information may, for example, comprise: a decryption key; an encrypted decryption key; a seed to a one-way function which is operative to produce a decryption key given the seed as input; or any other appropriate decryption information.

3. The cost for usage of the product such as, for example, cost information relating to buying, renting, or “pay per play”.

The multi-level product payment policy 650 preferably includes a billing model associated with the product, embodied in the MLPL as described above. For example, and without limiting the generality of the foregoing, an appropriate billing model might be to pay 5 previous generations, with a fixed payment to the first previous generation, and where each previous generation receives 2% less than the next generation. However, only users that pay the monthly fee may preferably derive financial benefit from distributing the secured electronic content 220. Furthermore, each user will receive for example a 1% benefit in each generation if the user paid more than $50 for rendering the secured electronic content 220.

The Multi-level product manager 640 preferably passes the multi-level product payment policy 650 to the multi-level payment gateway 570. The multi-level payment gateway 570 preferably utilizes the associated TRU 580 to authorize a third party payment “cash register” financial gateway 590 to administer payments to parties involved in recruiting the current user. In the example of FIG. 3, payments are administered to the plurality of bank accounts generally designated 600, and comprising a distributor bank account 610, a User 1 bank account 620, and a user 2 bank account 630.

In an alternative preferred embodiment of the invention, the MLPL makes all financial transactions automatically.

The Multi-level product manager 640 preferably passes the Multi-level product license 660 to the license server 670 which generates a license 680 which enables User 1 PC 510 and User 2 PC 530 to utilize secured electronic content 505.

In FIG. 3, by way of example only, one license 680 is shown as generated for purposes of simplicity of description. In actuality separate licenses with separate terms and conditions are preferably generated for each end user by any appropriate means as is well known in the art.

In a preferred embodiment of the present invention automated rule creation of payment systems is applied to the marketing of electronic content to create an automated multi-level marketing security system in which a multi-level marketing structure is added to a super distribution system. Security is also automated. Digital signature packets as opposed to manual signatures are used to ensure that necessary payments are made and ancestral order is preserved.

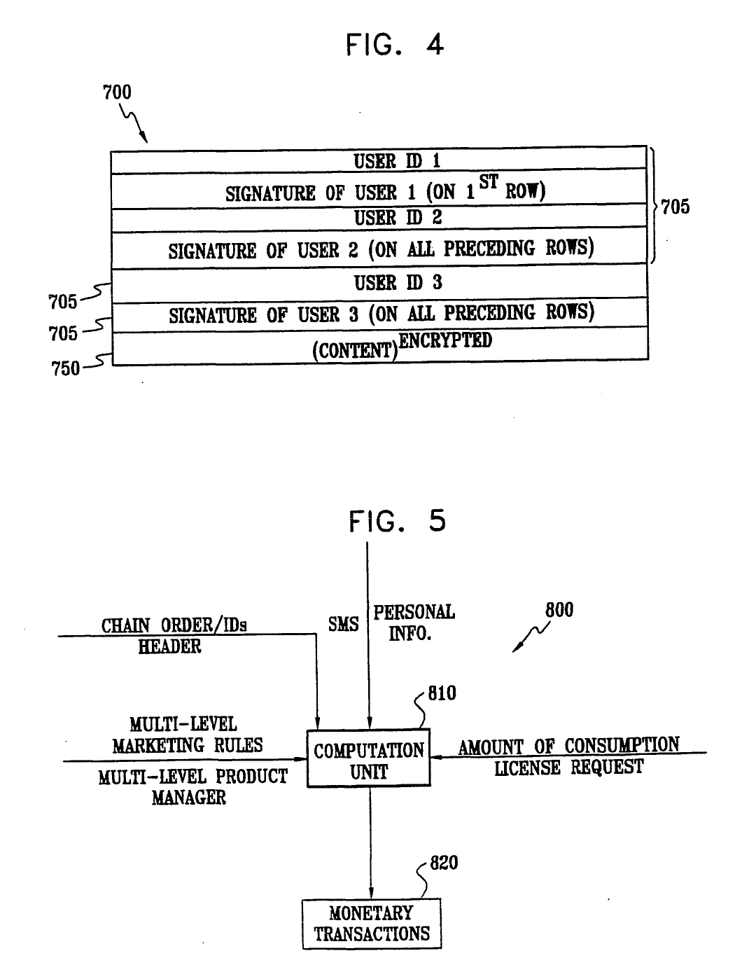

It will be appreciated that the ancestral order is very important because the ancestral order preferably determines the amount of payment to each worker. Security mechanisms, a preferred embodiment of which is described below with reference to FIG. 4, preferably protect each user's information and the user's order in the ancestral chain, and prevent each worker from tampering with the information already attached to the file. The purpose of a security mechanism, such as that described below with reference to FIG. 4, is to make it impossible for a user to change the ancestral order without being recognized. Signing is preferably used in order to make the data tamper evident. When all previous user data is signed by the current user as below with reference to FIG. 4, the data is termed herein “iteratively signed”.

Once the user is caught tampering, the user will preferably be added to a blacklist automatically. The blacklisted user will preferably be prevented from receiving payment from the distributor/content provider 210.

Payment to the distributor/content provider may be associated with the ability to render electronic content. The transmission of payment details may preferably be necessary before the user can render the content.

An end user may preferably need to “earn” the right to be a distributor. For example and without limiting the generality of the foregoing, an end user may need to play a song three times before the end user can distribute the song. An end user may also earn more money from distribution the more the end user personally renders (and pays for use of) the product according to the rules administered via the MLPL.

Reference is now made to FIG. 4, which is a simplified block diagram illustration of a preferred implementation of a file rendering system utilizable for the super distribution of electronic content in accordance with the preferred implementation of FIG. 3.

Within a multi-level file, for example file 700, a list of each end user's identification is preferably embedded in the file header 705 and is further preferably encrypted. The information is preferably placed in a specific order to reflect the hierarchy of payment ancestors and is preferably signed to ensure data integrity and to attempt to make the data tamper-proof.

The header 705 preferably includes a plurality of user IDs and user signatures. The user ID of the first user is conceptually on the first line of the header 705. The signature of the first user preferably certifies the integrity of the first user's ID, and preferably secures the first user's position in the ancestral chain.

The user ID of the second user conceptually appears on the third line of the header 705. A signature of the second user preferably signs each line that comes before it. The signature of the second user preferably certifies the integrity of the second user's ID, preferably secures the second user's position in the ancestral chain, and preferably certifies the integrity of all of the information in the header entered prior to the second user's information, preferably including the first user's signature.

By extension, there is preferably a user ID for each additional user and a digital signature associated with that user which preferably certifies the integrity of that user's information, that user's position in the ancestral order, and preferably all of the information in the header entered prior to the time when that user's information was entered. This orientation of data enables the system to diagnose which user tried to tamper with the data by pinpointing which signature/secure checksum did not match the data. The user who tampered will preferably be punished automatically by being added to the blacklist, as described above.

In the example of FIG. 4 and the description thereof above, references to “lines” are appreciated to be for the purpose of simplicity of description only and are not meant to be limiting, it being appreciated that a wide variety of possible formats may be used for the header 705.

Following the header 705 is secured electronic content 750, where the secured electronic content 750 is preferably encrypted with a different key and a separate algorithm from those used for the user information. It is appreciated that the order in which components are shown to appear in FIG. 4, namely with the secured electronic content 750 appearing after the header 705, is by way of example only and is not meant to be limiting.

Referring back to FIG. 3, when a new user receives the file, the new user's user unit preferably first fetches the license 680 from the license server 670 The new user's TRU passes the new user's personal information, which was downloaded by the business manager's SMS 560, from the new user's TRU to the license server 670, and the license server checks whether the new user is authorized to open secured electronic content 750.

Preferably, if the new user is authorized, the license server 670 passes an encrypted seed and usage cost to the secure software of the client. The client displays the usage cost, such as, for example, cost to rent, buy, or “pay per play”, to the end user and requests confirmation of the transaction. Once the end user agrees the software produces the appropriate key as a function of the secure seed and enables an internal decrypter to decrypt the content within the PC. A tamper resistant unit such as the user 1 tamper resistant unit (TRU) 540, which may comprise a removable security element such as a smart card or a similar removable security element, monitors the usage of the end user (based on type of transaction and number of renderings, for example) and computes the cost of this product in the secure storage device.

It is appreciated that the particular encryption/decryption method described is an example of a preferred method, and that other methods may alternatively be used.

Upon completion of the transaction or at periodic times, the secure device preferably reports back the cost of the usage and the secure multi-level header to the multi-level payment gateway 570. The multi-level payment gateway 570 preferably decrypts the secure multi-level header which contains ancestor information for the current user's recruitment and automatically pays, such as via an E-commerce credit card transaction or another appropriate means of payment, each ancestor and the merchant according to the payment policy. The multi-level payment gateway 570 obtains all credit card information, for example, of all subscribed users from the SMS 560 and automatically bills each credit card by mapping the secure user ID.

When the end user decides to copy the file to another end user, the secure copying software first passes the header 705 (FIG. 4) to the secure storage device. The secure storage device will append the end user's information comprising, for example, user ID, in encrypted format and sign the entire header to preferably ensure that the order is tamper proof.

In another preferred embodiment of the present invention, payment may only be administered to end users who pay the merchant a monthly fee for the privilege to be paid distributors of secured electronic content 220 The secure storage device is updated on a monthly basis by the business manager's SMS, via an EMM-like packet. In one preferred embodiment of the present invention, the secure storage device only appends user information for entries where a “paid membership” bit is set, to a file which will be used to administer payment to distributors in good standing.

Reference is now made to FIG. 5, which is a functional block diagram of a preferred implementation of a multi-level payment gateway which implements the payment policy associated with the super distribution of electronic content in accordance with the preferred implementation of FIG. 3.

The apparatus of FIG. 5, generally designated 800, preferably comprises a computation unit 810, which processes various inputs to output appropriate monetary transactions 820. Inputs to the computation unit 810 preferably comprise personal information from the SMS 560 of FIG. 3, the amount of consumption from a license request, multi-level marketing rules from the multi-level product manager 640 of FIG. 3 and the chain order/IDs from the header 705 of FIG. 4.

Inputs to the computation unit 810 comprise the chain order/IDs of users of secured electronic content 220 preferably obtained from the header, each user's personal information preferably obtained from the SMS 560, the amount of consumption that the user is to be billed for, preferably obtained from the licensing request. Multi-level marketing rules preferably obtained from the multi-level product manager are applied to the other inputs of computation unit 810 to determine which monetary transaction 820 needs to be administered.

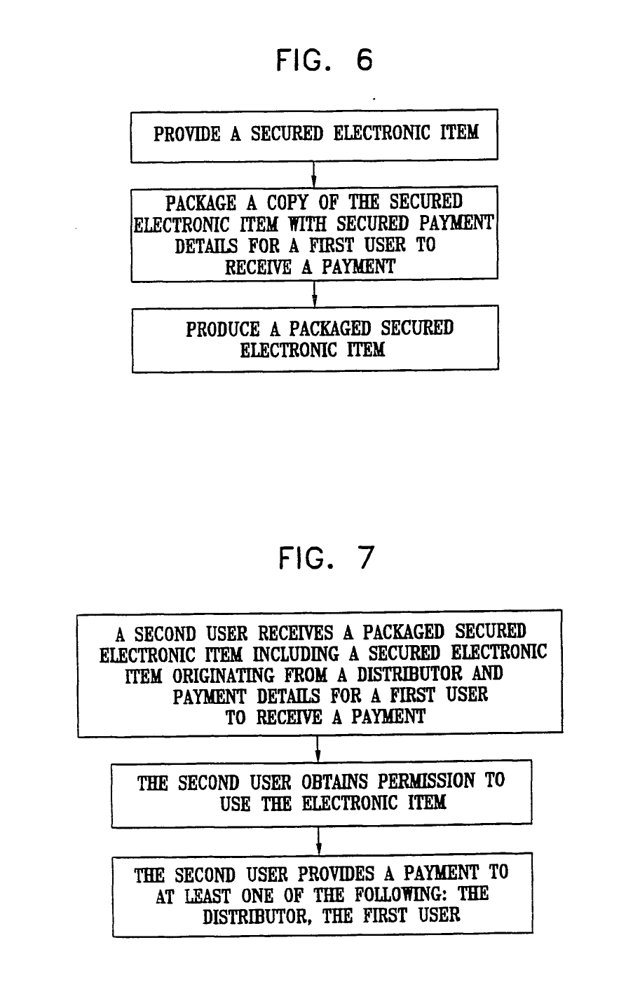

Reference is now made to FIG. 6, which is a simplified flowchart illustration of a preferred method of operation of the systems of FIGS. 2 and 3. The method of FIG. 6 is self-explanatory with reference to the above description of FIGS. 2 and 3.

Reference is now made to FIG. 7, which is a simplified flowchart illustration of an alternative preferred method of operation of the systems of FIGS. 2 and 3. The method of FIG. 7 is self-explanatory with reference to the above description of FIGS. 2 and 3.

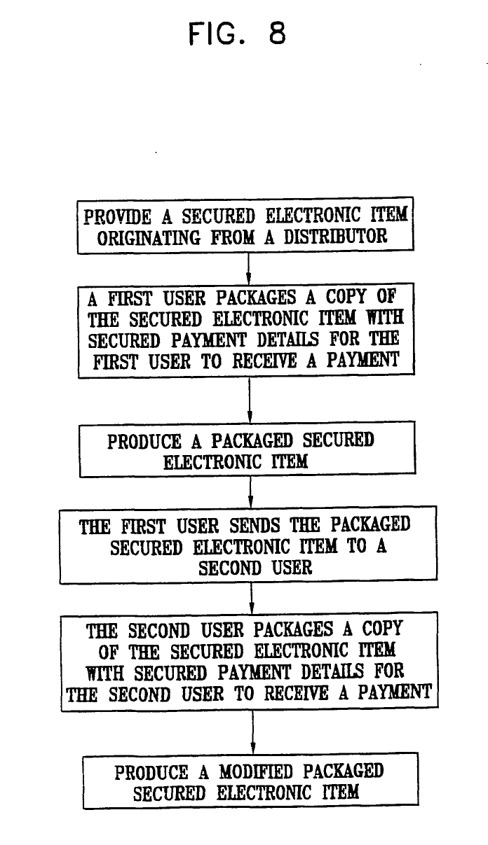

Reference is now made to FIG. 8, which is a simplified flowchart illustration of another preferred method of operation of the systems of FIGS. 2 and 3. The method of FIG. 8 is self-explanatory with reference to the above description of FIGS. 2 and 3.

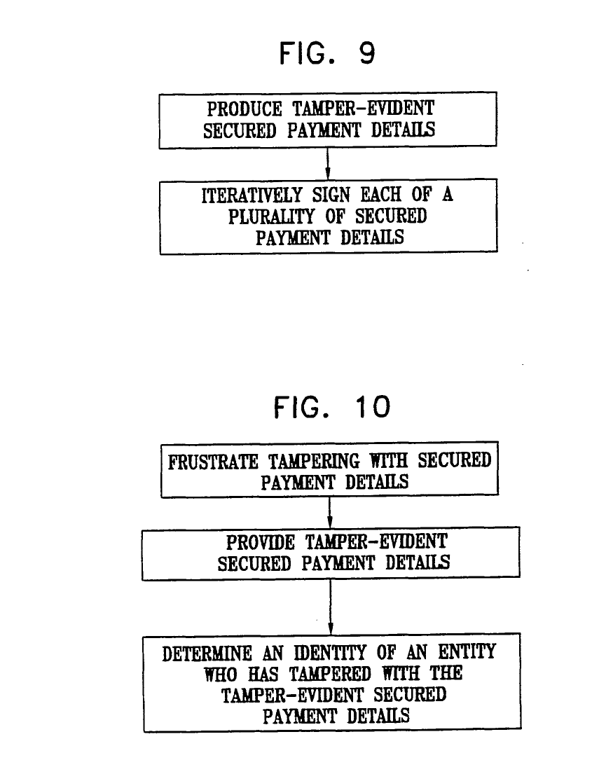

Reference is now made to FIG. 9, which is a simplified flowchart illustration of a further alternative preferred method of operation of the systems of FIGS. 2 and 3. The method of FIG. 9 is self-explanatory with reference to the above description of FIGS. 2 and 3.

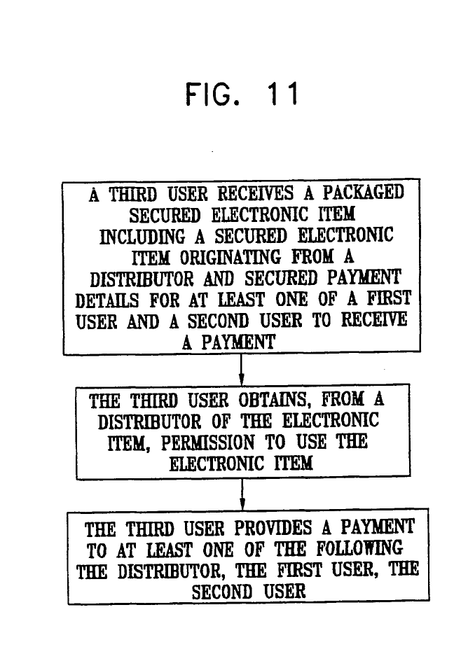

Reference is now made to FIG. 10, which is a simplified flowchart illustration of another preferred method of operation of the systems of FIGS. 2 and 3. The method of FIG. 10 is self-explanatory with reference to the above description of FIGS. 2 and 3.

Reference is now made to FIG. 11, which is a simplified flowchart illustration of a further alternative preferred method of operation of the systems of FIGS. 2 and 3. The method of FIG. 11 is self-explanatory with reference to the above description of FIGS. 2 and 3.

It is appreciated that various features of the invention which are, for clarity, described in the contexts of separate embodiments may also be provided in combination in a single embodiment. Conversely, various features of the present invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

What is claimed is:

1. A packaged secured electronic item comprising:
a secured electronic item originating from a distributor; and
secured payment details for a first user to receive a payment associated with use of the secured electronic item by a second user.

2. A method for automated multi-level marketing of an electronic item, the method comprising:
providing a secured electronic item originating from a distributor; and
a first user packaging a copy of the secured electronic item with secured payment details for the first user to receive a payment, thereby producing a packaged secured electronic item.

3. The method according to claim 2 and also comprising:
transmitting the packaged secured electronic item to a second user.

4. The method according to claim 3 and also comprising:
the second user obtaining, from the distributor, permission to use the electronic item; and
the second user providing a payment to at least one of the following:
the distributor; and
the first user.

5. The method according to claim 4 and wherein the second user providing a payment includes the second user providing a payment in accordance with a payment rule.

6. The method according to claim 5 and wherein the payment rule is automatically managed.

7. The method according to claim 6 and wherein the payment rule is automatically managed in accordance with at least one rule expressed in a payment rule language.

8. The method according to any of claims 5-7 and wherein the payment rule is automatically enforced.

9. The method according to any of claims 5-8 and wherein the payment rule is modifiable.

10. The method according to claim 9 and wherein the payment rule is modifiable during a life span of a product with which the payment rule is associated.

11. The method according to any of claims 5-10 and wherein the payment rule comprises at least one of the following: a rental rule; a pay-per-play rule; a pay-per-use rule; a buy rule; and a distributor payment rule.

12. The method according to claim 11 and wherein the distributor payment rule comprises at least one of the following: a rule determining distributor payment based, at least in part, on paid usage by a distributor; and a rule determining distributor payment based, at least in part, on whether a distributor has paid a monthly distributor fee.

13. The method according to any of claims 5-12 and wherein the rule includes information specifying an amount to be paid and a payment recipient associated with the amount to be paid.

14. The method according to any of claims 4-13 and wherein the second user provides a payment to at least one of the following: the distributor; and the first user.

15. The method according to claim 4 and wherein the second user provides a payment to both the distributor and the first user.

16. The method according to either claim 4 or claim 15 and wherein the payment is paid online.

17. The method according to either claim 4 or claim 15 and wherein the payment is paid offline.

18. A method for multi-level marketing of an electronic item, the method comprising:
a second user receiving a packaged secured electronic item comprising:
a secured electronic item originating from a distributor; and
secured payment details for a first user to receive a payment;
the second user obtaining, from a distributor of the electronic item, permission to use the electronic item; and
the second user providing a payment to at least one of the following:
the distributor; and
the first user.

19. The method according to claim 18 and wherein the second user provides a payment to both the distributor and the first user.

20. The method according to either claim 18 or claim 19 and wherein the payment is paid online.

21. The method according to either claim 18 or claim 19 and wherein the payment is paid offline.

22. A method for automated multi-level marketing of an electronic item, the method comprising:
providing a secured electronic item originating from a distributor; and
a first user packaging a copy of the secured electronic item with secured payment details for the first user to receive a payment, thereby producing a packaged secured electronic item;
the first user sending the packaged secured electronic item to a second user; and
the second user packaging a copy of the secured electronic item with secured payment details for the second user to receive a payment, thereby producing a modified packaged secured electronic item;

23. The method according to claim 22 and also comprising:
transmitting the packaged secured electronic item to a third user;

24. The method according to claim 23 and also comprising:
the third user obtaining, from the distributor, permission to use the electronic item; and
the third user providing a payment to at least one of the following:
the distributor;
the first user; and
the second user.

25. The method according to claim 24 and wherein the third user providing a payment includes the third user providing a payment in accordance with a payment rule.

26. The method according to claim 25 and wherein the payment rule is automatically managed.

27. The method according to claim 25 or claim 26 and wherein the payment rule is automatically enforced.

28. The method according to any of claims 25-27 and wherein the rule includes information specifying an amount to be paid and a payment recipient associated with the amount to be paid.

29. The method according to any of claims 24-28 and wherein the third user provides a payment to at least one of the following: the distributor; the first user; and the second user.

30. The method according to claim 29 and wherein the third user provides a payment to the distributor, the first user, and the second user.

31. The method according to claim 30 and wherein the user provides a payment to the distributor; the first user; and the second user.

32. The method according to any of claims 24-31 and wherein the payment is paid online.

33. The method according to any of claims 24-31 and wherein the payment is paid offline.

34. The method according to any of claims 22-33 and wherein the secured payment details comprise tamper-evident secure payment details.

35. The method according to claim 34 and wherein the tamper-evident secure payment details comprise iteratively signed secure payment details.

36. The method according to claim 34 or claim 35 and also comprising:
determining an identity of an entity who has tampered with the tamper-evident secure payment details.

37. The method according to claim 36 and also comprising:
blacklisting the entity who has tampered with the tamper-evident secure payment details.

38. A secure payment item comprising:
a tamper-evident secure payment list comprising:
a plurality of iteratively signed secure payment details.

39. A method for producing tamper-evident secured payment details comprising:
iteratively signing each of a plurality of secured payment details.

40. A method for frustrating tampering with payment details, the method comprising:
providing tamper-evident secured payment details; and
determining an identity of an entity who has tampered with the tamper-evident secured payment details.

41. The method according to claim 40 and also comprising:
blacklisting the entity who has tampered with the tamper-evident secure payment details.

42. A method for multi-level marketing of an electronic item, the method comprising:
a third user receiving a packaged secured electronic item comprising:
a secured electronic item originating from a distributor; and
secured payment details for at least one of a first user and a second user to receive a payment;
the third user obtaining, from a distributor of the electronic item, permission to use the electronic item; and
the third user providing a payment to at least one of the following:
the distributor;
the first user; and
the second user.

43. The method according to claim 42 and wherein the third user provides a payment to both the distributor and the first user.

44. The method according to claim 42 and wherein the third user provides a payment to the distributor, the first user, and the second user.

45. The method according to either claim 42 or claim 43 and wherein the payment is paid online.

46. The method according to either claim 42 or claim 43 and wherein the payment is paid offline.
